(19) United States
(12) Patent Application Publication
(10) Pub. No.: US 2026/0183593 A1
(43) Pub. Date: Jul. 2, 2026

(54) FIREFIGHTING FOAM COMPOSITION

(71) Applicant: Stepan Company, Northbrook, IL (US)

(72) Inventors: John Christopher Hutchison, Lincolnwood, IL (US); Catherine Bertholf, Glenview, IL (US); Xue Min Dong, Lincolnshire, IL (US); Jason Scott Keiper, Skokie, IL (US)

(21) Appl. No.: 19/545,793

(22) Filed: Feb. 20, 2026

Related U.S. Application Data
(63) Continuation of application No. PCT/US24/43166, filed on Aug. 21, 2024.
(60) Provisional application No. 63/534,228, filed on Aug. 23, 2023.

(51) Int. Cl. A62D 1/02; A62D 1/00; C09K 21/08; C09K 21/10

(52) U.S. Cl. CPC A62D 1/0071; A62D 1/0042; C09K 21/08; C09K 21/10

(57) ABSTRACT

A firefighting foam concentrate that is free or substantially free of fluorosurfactants is disclosed. The firefighting foam concentrate comprises water and from 25% to 38% by weight of a surfactant blend comprising at least one selected cationic quaternary ammonium compound, at least one selected alkyl amine oxide nonionic surfactant, and at least one selected alkyl sulfate anionic surfactant. Each selected surfactant has an average alkyl or alkylene carbon chain length of 8-10 carbon atoms. The firefighting foam concentrate may be combined with other firefighting foam components to form a firefighting foam composition. Also disclosed is a method of fighting a fire comprising aerating the firefighting foam composition containing the surfactant blend to form a firefighting foam that is applied to a fire or the surface of a volatile flammable liquid.

### FIELD OF THE INVENTION

The present technology relates to surfactant blends for firefighting foam concentrates and compositions, and in particular, to surfactant blends that are free or substantially free from fluorocarbon compounds.

### BACKGROUND OF THE INVENTION

Class-B fires are those involving flammable liquids, such as gasoline, kerosene, and other fuels and hydrocarbons. Aqueous film-forming foams (AFFFs) for class-B firefighting applications must be able to extinguish the fire, form a robust foam in the presence of hydrocarbons, and be a barrier to the hydrocarbon vapors. Conventional AFFFs for class-B fires typically comprise proprietary blends of fluorinated surfactants and other materials, and rely on the unique properties of fluorosurfactants to produce foam that can spread over the surface of hydrocarbon liquids and seal in any flammable volatile components, thereby extinguishing a fire and preventing reignition of the hot hydrocarbon liquid. Fluorosurfactants, however, have been the subject of scrutiny because of the mounting evidence that they bio-accumulate and could be carcinogenic. There is therefore an increasing drive in the marketplace to eliminate or substantially reduce the use of fluorosurfactants in firefighting foams. One difficulty is that many non-fluorinated surfactants do not have properties comparable to those of fluorosurfactants, resulting in AFFFs having inferior firefighting properties. A continuing need exists for non-fluorinated surfactants that are safer from a health and environmental standpoint, yet can meet the demanding requirements of AFFFs for class-B firefighting applications.

Applicants have determined that surfactant blends comprising particular cationic, anionic, and nonionic surfactants having particular carbon chain lengths can provide firefighting foam concentrates and compositions with properties suitable for use in class-B firefighting applications while also advancing U.N. Sustainability Goals (“SDG”). The surfactants can be derived from renewable fatty acid feedstocks, and can be an effective replacement for fluorosurfactants that negatively impact health and the environment. These benefits further SDG #3 (Good Health and Well-Being) and SDG #12 (Responsible Consumption and Production).

### BRIEF SUMMARY OF THE INVENTION

The present technology generally relates to aqueous firefighting foam concentrates comprising a surfactant blend comprising at least one quaternary ammonium cationic surfactant having one or two carbon chains having an average carbon chain length of 8 to 10 carbon atoms, at least one amine oxide nonionic surfactant having a carbon chain with an average carbon chain length of 8 to 10 carbon atoms, and at least one alkyl sulfate anionic surfactant having an average carbon chain length of 8 to 10 carbon atoms. Surprisingly, it has been found that the combination of cationic, nonionic, and anionic surfactants having particular carbon chain lengths provides a synergistic surfactant blend having properties suitable for use in AFFF class-B firefighting foam applications.

One aspect of the present technology is an aqueous firefighting foam concentrate comprising a surfactant blend in an amount of about 25% to about 38% by weight of the concentrate, the surfactant blend comprising (i) a cationic surfactant having the general formula:

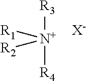

where R₁ is a straight or branched, saturated or unsaturated, alkyl or alkene chain having an average chain length of 8 to 10 carbon atoms; R₂ is H or a straight or branched, saturated or unsaturated, alkyl or alkene chain having from 1 to 10 carbon atoms; R₃ is H, methyl or ethyl; R₄ is H, methyl or ethyl; and X⁻ is a monovalent anion, preferably a halide; (ii) an alkyl amine oxide nonionic surfactant having an alkyl moiety with an average carbon chain length of 8 to 10 carbon atoms; and (iii) an anionic surfactant having the general formula:

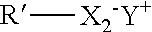

where R′ is a straight or branched, saturated or unsaturated, alkyl or alkene chain having an average chain length of 8 to 10 carbon atoms, X₂⁻ is a sulfate group, and Y⁺ is a cationic counter ion preferably selected from the group consisting of sodium, potassium, and ammonium; wherein the cationic surfactant, the nonionic surfactant, and the anionic surfactant are present in the surfactant blend in a molar ratio of about 0.25-1.0:0.25-1.0:0.25-1.0; and water to total 100% by weight of the concentrate.

Another aspect of the present technology is a firefighting foam composition comprising (a) about 0.5% to about 12% by weight of the composition of a surfactant blend comprising (i) a cationic surfactant having the general formula:

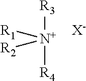

where R₁ is a straight or branched, saturated or unsaturated, alkyl or alkene chain having an average chain length of 8 to 10 carbon atoms; R₂ is H or a straight or branched, saturated or unsaturated, alkyl or alkene chain having from 1 to 10 carbon atoms; R₃ is H, methyl, or ethyl; R₄ is H, methyl, or ethyl; and X⁻ is a monovalent anionic counterion, preferably a halide, most preferably Cl⁻ or Br⁻; (ii) an alkyl amine oxide nonionic surfactant having an alkyl moiety with an average carbon chain length of 8 to 10 carbon atoms; and (iii) an anionic surfactant having the general formula:

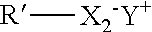

where R′ is a straight or branched, saturated or unsaturated, alkyl or alkene chain having an average chain length of 8 to 10 carbon atoms, X₂⁻ is a sulfate group, and Y⁺ is a cationic counter ion preferably selected from the group consisting of sodium, potassium, ammonium, and substituted ammonium; wherein the cationic surfactant, the nonionic surfactant, and the anionic surfactant are present in the surfactant blend in a molar ratio of about 0.25-1.0:0.25-1.0:0.25-1.0; (b) at least one additive selected from the group consisting of thickeners, foam stabilizers, and polymers; and (c) water to total 100% by weight of the composition.

Another aspect of the present technology is a method for fighting a fire comprising (a) aerating a firefighting foam composition to form an aerated firefighting foam; and (b) applying the aerated firefighting foam to a fire, wherein the firefighting foam composition comprises water and about 0.5% to about 12% by weight of the composition of a surfactant blend comprising (i) a cationic surfactant having the general formula:

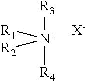

where R₁ is a straight or branched, saturated or unsaturated, alkyl or alkene chain having an average chain length of 8 to 10 carbon atoms; R₂ is H or a straight or branched, saturated or unsaturated, alkyl or alkene chain having from 1 to 10 carbon atoms; R₃ is H, methyl, or ethyl; R₄ is H, methyl or ethyl; and X⁻ is a monovalent anion, preferably a halide; (ii) an alkyl amine oxide nonionic surfactant having an alkyl moiety with an average carbon chain length of 8 to 10 carbon atoms; and (iii) an anionic surfactant having the general formula:

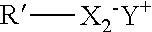

where R′ is a straight or branched, saturated or unsaturated, alkyl or alkene chain having an average chain length of 8 to 10 carbon atoms, X₂⁻ is a sulfate group, and Y⁺ is a cationic counter ion preferably selected from the group consisting of sodium, potassium, ammonium, and substituted ammonium; wherein the cationic surfactant, the nonionic surfactant, and the anionic surfactant are present in the surfactant blend in a molar ratio of about 0.25-1.0:0.25-1.0:0.25-1.0.

### BRIEF DESCRIPTION OF THE DRAWINGS

FIG. 1 is a graph showing the surface tension vs. concentration profile of surfactant blends of the present technology.

### DETAILED DESCRIPTION OF THE INVENTION

While the presently described technology will be described in connection with one or more preferred embodiments, it will be understood by those skilled in the art that the technology is not limited to only those particular embodiments. To the contrary, the presently described technology includes all alternatives, modifications, and equivalents that can be included within the spirit and scope of the appended claims.

As used herein, the term “substantially free of fluorocarbons” means the concentrate or composition contains no more than 0.01 wt % of fluorocarbons.

As used herein, “firefighting foam concentrate” refers to an aqueous surfactant blend having a surfactant concentration of about 25% to about 38% by weight of the concentrate.

As used herein, “firefighting foam composition” refers to an aqueous composition comprising a blend of surfactants in combination with additional components typically used in firefighting applications. Firefighting foam compositions are intended to be mixed with a diluent, such as water, to a use strength for fighting a fire.

As used herein, a “diluent” or “carrier” means a liquid substance, or mixture of substances, that can be used as a delivery vehicle or carrier to prepare or dilute the firefighting foam concentrate or composition of the present technology. A diluent can be, for example, water.

“About” means+/−10% of the referenced value. In certain embodiments, about means+/−5% of the referenced value, or +/−4% of the referenced value, or +/−3% of the referenced value, or +/−3% of the referenced value, or +/−2% of the referenced value, or +/−1% of the referenced value.

The present technology generally relates to surfactant blends for use in aqueous firefighting foam concentrates and compositions, particularly class-B firefighting foam compositions. The surfactant blends comprise particular quaternary ammonium cationic surfactants, particular alkyl amine oxide nonionic surfactants, and particular alkyl sulfate anionic surfactants in particular molar ratios. An important aspect of the present technology is that the surfactants in the surfactant blend have hydrophobic alkyl or alkylene carbon chain lengths that average 8 to 10 carbon atoms. In other words, the average of all the hydrophobic alkyl or alkylene chains for all the surfactants in the surfactant blend is 8 to 10 carbon atoms. In some embodiments, each of the quaternary ammonium cationic surfactant, the amine oxide nonionic surfactant, and the alkyl sulfate anionic surfactant components in the surfactant blend has carbon chain lengths in the range of 8 to 10 carbon atoms. In other embodiments, the quaternary ammonium cationic surfactant, the amine oxide nonionic surfactant, and the alkyl sulfate anionic surfactant may have hydrophobic alkyl or alkylene moieties having carbon chain lengths that are greater than 10 or less than 8 carbon atoms, provided the average of the hydrophobic alkyl or alkylene chains for all the surfactants in the surfactant blend is in the range of 8 to 10 carbon atoms.

Preferably, the particular selected surfactants in the blend are at least one quaternary ammonium cationic surfactant having one or two carbon chains having an average carbon chain length of 8 to 10 carbon atoms, at least one amine oxide nonionic surfactant having an alkyl moiety with a carbon chain length of 8 to 10 carbon atoms, and at least one alkyl sulfate anionic surfactant having a carbon chain length of 8 to 10 carbon atoms. The selected surfactants having these particular carbon chain lengths work synergistically to provide a balance of physical properties that make the surfactant blend particularly suitable for use in class-B firefighting foams. In particular, an aqueous solution comprising the surfactant blend has a relatively low surface tension (less than 25.5 mN/m), a moderate interfacial tension between aqueous and oil phases (between 0.2 and 3.5 mN/m), and a relatively fast dynamic surface tension that can reach a meso-equilibrium surface tension in about 100 ms. Low surface tension of the composition favors spreading of the foam over a hydrocarbon surface. Moderate or intermediate interfacial tension between the aqueous and hydrocarbon phases is desirable to prevent the hydrocarbon from infusing into the foam and imparting flammability. Fast dynamic surface tension is a measure of how quickly the surfactants lower the surface tension and is believed to be an indication of how quickly a foam can coat a surface.

Not to be bound by any particular theory, it is believed that the combination of the particular surfactants in specific amounts provides the desired combination of relatively low surface tension, moderate interfacial tension between aqueous and oil phases, and fast dynamic surface tension. If one or more of the surfactants in the surfactant blend have average hydrophobic carbon chain lengths that are not within the range of 8 to 10 carbon atoms such that the overall average of all the hydrophobic alkyl or alkylene chains in the surfactant blend is not within the range of 8 to 10 carbon atoms, the resulting concentrate or composition may not provide the desired combination of properties. Similarly, a composition that uses a different surfactant component, or omits one of the surfactant components, may not provide the combination of properties.

### Quaternary Ammonium Cationic Surfactant

Suitable quaternary ammonium compounds for use herein have the general formula:

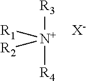

where R₁ is a straight or branched, saturated or unsaturated, alkyl or alkene chain having an average carbon chain length of 8 to 10 carbon atoms;
R₂ is H or a straight or branched, saturated or unsaturated, alkyl or alkene chain having from 1 to 10 carbon atoms, preferably 1 carbon atom;
R₃ is H, methyl, or ethyl;
R₄ is H, methyl, or ethyl; and
X⁻ is a monovalent anionic counterion, preferably a halide, and most preferably Cl⁻ or Br⁻.

Exemplary quaternary ammonium compounds within the general formula include alkyl (C8-C10) trimethyl ammonium halide and dialkyl (C8-C10) dimethyl ammonium halide. The quaternary ammonium compound may have some R₁ carbon chain lengths of greater than 10 carbons or less than 8 carbons, provided the average chain length for the hydrophobic alkyl or alkylene chains in the surfactant blend is 8 to 10 carbon atoms. Specific quaternary ammonium salts include decyltrimethyl ammonium chloride, decyltrimethyl ammonium bromide, octyltrimethyl ammonium chloride, octyltrimethyl ammonium bromide, and didecyl dimethyl ammonium chloride. The quaternary ammonium compound need not be a single entity, but may be a blend of two or more quaternary ammonium compounds.

### Amine Oxide Nonionic Surfactant

The firefighting foam concentrates of the present technology also include at least one amine oxide nonionic surfactant having a hydrophobic alkyl moiety containing an average of from 8 to 10 carbon atoms and 2 moieties containing from 1 to 3 carbon atoms, preferably 1 carbon atom. The C8-C10 alkyl moiety may be straight or branched. The amine oxide may be a mixture of alkyl amine oxides having different chain lengths, provided the average chain length of the longer chain alkyl moiety is 8 to 10 carbon atoms. Alternatively, the longer chain alkyl or alkylene moiety could have a carbon chain length greater than 10 or less than 8, provided the average chain length for all the hydrophobic alkyl or alkylene chains present in the surfactant blend is 8 to 10 carbon atoms. Suitable amine oxides for use in the present technology include octyldimethylamine oxide and decyldimethylamine oxide. Combinations of amine oxides may also be used.

### Alkyl Sulfate Anionic Surfactant

In addition to the cationic quaternary ammonium compound and the amine oxide nonionic surfactant, the firefighting foam concentrates of the present technology include at least one alkyl sulfate anionic surfactant having the general formula:

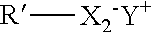

where R′ is a straight or branched, saturated or unsaturated, alkyl or alkylene group having an average carbon chain length of 8 to 10 carbon atoms; X₂⁻ is a sulfate group; and Y⁺ is a monovalent or divalent cationic counterion. Preferably, the counterion is selected from sodium, potassium, ammonium, and substituted ammonium, such as mono-, di-, and triethanolamine. The alkyl sulfate may have carbon chain lengths of greater than 10 carbons or less than 8 carbons, provided the average chain length for all the hydrophobic alkyl or alkylene chains present is 8 to 10 carbon atoms. Suitable alkyl sulfates for use in the present technology include octyl sulfate, decyl sulfate, or a combination thereof, such as POLYSTEP® B-25 (sodium decyl sulfate) and POLYSTEP® B-29 (sodium octyl sulfate), available from Stepan Company, Northbrook, Illinois.

The cationic, nonionic, and anionic surfactants are present in the surfactant blend in a molar ratio of 0.25-1.0:0.25-1.0:0.25-1.0. In some embodiments, the molar ratio is 1:1:1. The surfactant blend may comprise from 25% to 38% by weight of the firefighting foam concentrate, with the remainder comprising a liquid carrier, preferably water. Alternatively, the surfactant blend may comprise about 30% to about 35% by weight of the firefighting foam concentrate. The surfactant blends are prepared by mixing the surfactants together in the liquid carrier such that the nonionic surfactant is always present. Standard mixing equipment is acceptable for preparing the firefighting foam concentrates.

### Liquid Carrier

The firefighting foam concentrates of the present technology are in liquid form and comprise a carrier in addition to the cationic quaternary ammonium compound, the amine oxide nonionic surfactant, and the alkyl sulfate anionic surfactant. Water is a typical carrier, and can be tap water, deionized water, purified water, or combinations thereof. Optionally, water-miscible solvents, such alcohols or glycol ethers, could be included in the liquid carrier, although preferably water is the only liquid carrier for the firefighting foam concentrates.

### Firefighting Foam Compositions

The firefighting foam concentrates can be combined with additional liquid carrier, such as water, and other components known in the art, such as thickeners, foam stabilizers, polymers, or other functional ingredients, to form a firefighting foam composition. Thickeners that can be used include polysaccharides, such as celluloses and cellulosic materials, and gums, such as guar gum, xanthan gum, gum Arabic, and gellan gum. Polymers that can be used are water-soluble or water-dispersible polymers. Examples of such polymers include polyacrylamides, polyacrylics, vinylacrylics, vinylacetates, and polyurethanes. Water can be used alone as the carrier, or in combination with other suitable carriers, such as for example, water-miscible solvents, such as alcohols or glycol ethers. The liquid carrier typically comprises about 50% to about 80% by weight, based on the total weight of the firefighting foam composition, alternatively about 60% to about 75% by weight, and the surfactants and additional components comprise about 20% to about 50% by weight, alternatively about 25% to about 40% by weight. The surfactant blend can comprise about 0.5% to about 12% by weight, based on the weight of the firefighting foam composition.

### Methods of Use

The firefighting foam compositions comprising the surfactant blend of the present technology are intended to be mixed with a diluent and foamed to provide a fire extinguishing composition that is applied directly to the fire. The diluent is typically water, and can be fresh water, municipal water, brine, sea water, or combinations thereof. In the dilution process, the firefighting foam composition can be mixed into a pressurized or flowing stream of water, such as through an in-line eductor. The firefighting foam composition may be aerated, such as through a nozzle, to form a foam that is applied to the fire or the surface of a flammable hydrocarbon liquid. Typically, firefighting foam compositions are defined as 3% or 6% concentrates, meaning they are intended to be diluted by the eductor to 3 vol % or 6 vol % in the diluent. For example, a 3% composition is mixed with 97 vol % diluent, and a 6% composition is mixed with 94 vol % diluent to obtain a composition at use dilution. It should be understood that other dilution amounts could be used for the firefighting foam compositions, and the concentrations of the solids components in the firefighting foam compositions can be adjusted accordingly to provide an effective amount of solids at use dilution.

The firefighting foam concentrates and compositions of the present technology may be used to extinguish class-B fires. For example, the firefighting foam concentrates and compositions may be used for fighting hydrocarbon fires in which the hydrocarbons are oils, fuel oil, diesel oil, kerosene, hexane, or cyclohexane. It is contemplated that the firefighting foam concentrates of the present technology could be used in any of the six types of concentrates defined by UL 162 as low-expansion foam concentrates.

The presently described technology and its advantages will be better understood by reference to the following examples. These examples are provided to describe specific embodiments of the present technology. By providing these specific examples, it is not intended to limit the scope and spirit of the present technology. It will be understood by those skilled in the art that the full scope of the presently described technology encompasses the subject matter defined by the claims appended to this specification, and any alterations, modifications, or equivalents of those claims.

### EXAMPLES

### Example 1: Surfactant Blends

Concentrated aqueous compositions comprising different surfactant blends of the present technology and comparative surfactant blends were prepared by combining the cationic, anionic, and nonionic (or amphoteric) surfactants in water such that the nonionic (or amphoteric) surfactant was always present in the composition. The surfactant concentration for each composition was about 35 wt %, and the molar ratio of surfactants in each composition was about 1:1:1. Table 1 shows the surfactant components in Compositions 1 and 2 of the present technology, and the surfactant components in Comparative compositions 1-5. For the Comparative compositions, either the anionic surfactant or the nonionic component is not according to the present technology.

TABLE 1

| | | | Nonionic or | Physical |
|---|---|---|---|---|
| Name | Cationic | Anionic | Amphoteric | Form |
| Composition 1 | Decyltrimethylammonium | Sodium | Octyldimethylamine | Clear liquid |
| | chloride | octylsulfate | oxide | |
| Composition 2 | Decyltrimethylammonium | Sodium | Octyldimethylamine | Clear liquid |
| | chloride | decylsulfate | oxide | |
| Comparative 1 | Octyltrimethylammonium | Sodium | Lauramidopropyl | Clear liquid |
| | chloride | decylsulfate | betaine | |
| Comparative 2 | Decyltrimethylammonium | Sodium | Octyldimethylamine | Clear liquid |
| | chloride | caprylyl | oxide | |
| | | sulfonate | | |
| Comparative 3 | Decyltrimethylammonium | Sodium | Cocamidopropyl | Clear liquid |
| | chloride | octylsulfate | betaine | |
| Comparative 4 | Cetrimonium chloride | Sodium | Myristyldimethylamine | Precipitate |
| | | decylsulfate | oxide | |
| Comparative 5 | decyltrimethylammonium | Sodium | Cocamidopropyl | Gel |
| | chloride | decylsulfate | betaine | |

Table 1 shows that substituting a quaternary ammonium compound having an alkyl chain length of 16 carbon atoms and an amine oxide having an alkyl chain length of 14 carbon atoms for the quaternary ammonium compound and amine oxide of the present technology, respectively (Comparative 4), or substituting a betaine for the alkyl amine oxide of the present technology (Comparative 5) can result in a composition that does not have acceptable physical or chemical stability.

### Example 2: Tensiometry Testing

Each of the compositions in Example 1 that was a clear liquid was evaluated for its surface tension (ST) in deionized (DI) water and in simulated seawater (prepared according to ASTM D1141). Each composition was also evaluated for its interfacial tension (IFT) against kerosene and cyclohexane. The compositions were diluted to a 0.1 wt % solution for the testing. STs were determined using a Kibron microtrough. IFT measurements were determined by a pendant drop method using a Kruss Drop Shape Analysis System DSA10. In this method, a drop of the denser phase is formed on the end of a capillary tip, which is pointed downward within the less dense phase. The drop is typically formed to about 90% of its detachment volume (from the capillary). The drop is then digitally imaged. The drop's image is fit by a robust mathematical approach to determine the drop's mean curvature at over 300 points along its surface.

The spreading coefficient Cs for each composition was determined according to the following equation:

$$Cs = {ST}_{HC} - ( {ST}_{AQ} + {IFT}_{HC - AQ} )$$

where ST_{HC} is the surface tension of the hydrocarbon, ST_{AQ} is the surface tension of the aqueous phase, and IFT_{HC-AQ} is the interfacial tension between the hydrocarbon and aqueous phases. The surface tension should be low (less than 25.5 mN/m) in order to favor spreading of the foam over the hydrocarbon surface. Spontaneous spreading occurs when the surface energy of the hydrocarbon-air interface is greater than the sum of the aqueous-air interface and the hydrocarbon-aqueous interface. In other words, spontaneous spreading will occur when Cs>0. Lower IFTs will favor spontaneous spreading. However, if the interfacial tension is too low, the two liquids will tend to emulsify. This can have a negative effect on AFFF performance since an emulsified hydrocarbon is more likely to permeate the aqueous film, resulting in a flammable mixture.

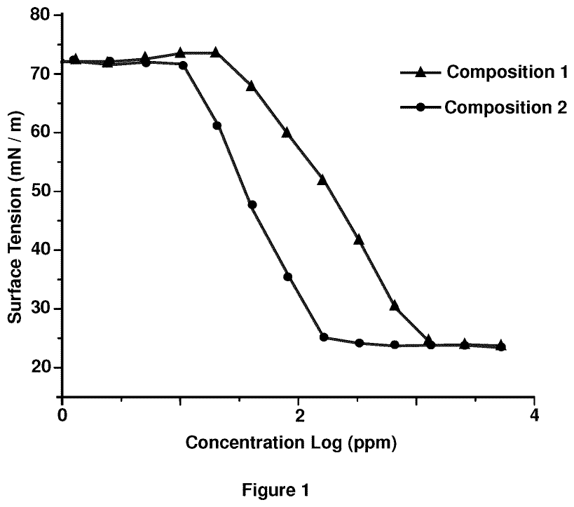

The following STs were used for the hydrocarbons:kerosene=27.0 mN/m, cyclohexane=25.5 mN/m. FIG. 1 shows the surface tension vs the concentration profiles for Compositions 1 and 2 from Example 1 in DI water. Table 2 below shows the surface tension, interfacial tension, and spreading coefficient results from testing the clear liquid compositions from Example 1.

TABLE 2

| | | IFT- | | Cs- | |
|---|---|---|---|---|---|
| | | Cyclo- | IFT- | Cyclo- | Cs- |
| | ST | hexane | Kerosene | hexane | Kerosene |
| Name | (mN/m) | (mN/m) | (mN/m) | (mN · m) | (mN/m) |
| Composition 1 | 24.53 | 1.07 | 0.53 | −0.10 | 1.94 |
| DI | | | | | |
| Composition 1 | 24.24 | 0.78 | 0.28 | 0.48 | 2.48 |
| SEA | | | | | |
| Composition 2 | 24.06 | 1.04 | 0.44 | 0.4 | 2.50 |
| DI | | | | | |
| Composition 2 | 23.48 | 0.88 | 0.31 | 1.14 | 3.21 |
| SEA | | | | | |
| Comparative 1 | 27.38 | ND | ND | <0 | <0 |
| DI | | | | | |
| Comparative 1 | 25.65 | ND | ND | <0 | <0 |
| SEA | | | | | |
| Comparative 2 | 25.47 | ND | ND | <0 | <0 |
| DI | | | | | |
| Comparative 2 | 25.09 | ND | ND | <0 | <0 |
| SEA | | | | | |
| Comparative 3 | 26.90 | ND | ND | <0 | <0 |
| DI | | | | | |
| Comparative 3 | 26.90 | ND | ND | <0 | <0 |
| SEA | | | | | |

The results in Table 2 show that only the compositions of the present technology had interfacial tensions and spreading coefficients that favor spontaneous spreading on hydrocarbons. Substituting an alkyl betaine surfactant for the amine oxide surfactant, or substituting an alkyl sulfonate anionic surfactant for the alkyl sulfate surfactant resulted in compositions having a surface tension above 25 mN/m and a Cs of less than zero. These results show that surfactant blends containing surfactants other than the selected surfactants of the present technology have surface properties that are insufficient for spontaneously spreading on hydrocarbon surfaces.

### Example 3: Foam Spreading Over Kerosene

Compositions 1 and 2 from Example 1 were evaluated for foam spreading over kerosene. For the test, each composition (300 uL) was diluted with either DI water or simulated seawater (4700 uL) in an 8 dram vial. Vigorous shaking of the vial produced foam, which was applied to the kerosene surface within 30 seconds of generation. The foam was transferred to the surface in 2×8.5 mL portions using a large disposable pipette with the tip cut off. The hydrocarbon surface was 10 mL of kerosene in a 60 mm diameter aluminum weighing dish. The foam was observed and qualities such as ease of spreading, foam quality, robustness to physical disruption, and longevity were noted.

The foams for both Composition 1 and Composition 2 readily spread over the kerosene surface and persisted for up to 30 minutes. When the foams were disturbed with a disposable pipette, the foams readily sealed around the disturbance, indicating resistance to physical disruption. The foams also did not emulsify the kerosene. After the foam had drained from the foam into the pan of kerosene, both the kerosene and the aqueous phase were clear, indicating no emulsification.

### Example 4: Vapor Permeation

Compositions 1 and 2 from Example 1 were tested for vapor permeation to determine how well the foams seal in flammable hydrocarbon vapors. For the test, each composition (300 uL) was diluted with either DI water or simulated seawater (4700 uL) in an 8 dram vial. Vigorous shaking of the vial produced foam, which was applied to the cyclohexane surface within 30 seconds of generation. The foam was transferred to the surface in 2×8.5 mL portions using a large disposable pipette with the tip cut off. The hydrocarbon surface was 2 mL of cyclohexane in a 60 mm diameter aluminum weighing dish. A flame from a cigarette lighter was held about 2 cm above the surface and the results observed. If ignition did not occur within 30 seconds, the flame was removed, the surface disturbed with a disposable pipette, and the flame reapplied.

The foams for both Composition 1 and Composition 2 readily spread over the cyclohexane surface and initially sealed in the vapors. The foams broke and ignited only after much mechanical disturbance.

### Example 5: Foam Longevity

Compositions 1 and 2 from Example 1 were evaluated to determine foam longevity and robustness on kerosene compared to sodium lauryl sulfate (SLS) surfactant and an ammonium alkyl ether sulfate surfactant (CEDEPAL® FA-406) known for its foaming ability. For the test, the compositions at concentrations of 0.5 wt %, 3 wt %, and 6 wt % in DI water were foamed using an Airspray foam pump matrix (43 mm neck, L11 Engine, 0.75 output) to generate the foam. The foam pump has an 11:1 air:liquid ratio with the liquid dosage being 0.75 ml. The generated foam was evenly dispersed into a 60 mm diameter aluminum weighing dish containing 4 mL of Aldrich grade kerosene, and immediately covered by a crystalline glass dish to prevent evaporation or disruption of the foam. The test is timed and completed when a breakthrough has occurred. A breakthrough is defined as the time it took for the foam to open or unseal allowing the hydrocarbon to become visible. The results are shown in Table 3.

TABLE 3

| Name | Concentration (wt %) | Time to Open (seconds) |
|---|---|---|
| Composition 1 | 0.5 | >3600 |
| Composition 2 | 0.5 | 2064 |
| SLS | 0.5 | 401 |
| CEDEPAL ® FA-406 | 0.5 | 304 |
| Composition 1 | 3.0 | >3600 |
| Composition 2 | 3.0 | >3600 |
| SLS | 3.0 | 2466 |
| CEDEPAL ® FA-406 | 3.0 | 226 |
| Composition 1 | 6.0 | >3600 |
| Composition 2 | 6.0 | ND |
| SLS | 6.0 | >3600 |
| CEDEPAL ® FA-406 | 6.0 | 503 |

The foams for both Composition 1 and Composition 2 had substantially longer lasting foams compared to the sodium lauryl sulfate and ammonium alkyl ether sulfate surfactants and showed robustness down to surfactant loadings of 0.5 wt %.

### Example 6: Dynamic Surface Tension

The dynamic surface tensions (DST's) of 0.1 wt % surfactant solutions against DI water at 25° C. were determined with a Kruss BP100 bubble pressure tensiometer. The surfactant solutions tested were the Composition 2 surfactant blend of decyltrimethylammonium chloride cationic surfactant, sodium decyl sulfate anionic surfactant, and octyldimethylamine oxide nonionic surfactant at different molar ratios within the range of 0.25-1:0.25-1:0.25-1, and each of the cationic, anionic, and nonionic surfactants alone as the only surfactant. The surfactant blend samples are according to the present technology and the single surfactant samples are comparative examples. Bubble pressure measurement parameters were: capillary diameter 0.356 mm, detection speed 20 mm/min, detection sensitivity 50 Pa. The DST results are shown in Table 4.

TABLE 4

| | Cationic | Anionic | Nonionic | DST, | DST, |
|---|---|---|---|---|---|
| | Surfactant, | Surfactant, | Surfactant, | mN/m | mN/m |
| | Relative | Relative | Relative | @ 1000 | @ 2000 |
| Name | Mole % | Mole % | Mole % | ms | ms |
| Composition 2 | 33.3% | 33.3% | 33.3% | 36.0 | 34.5 |
| Composition 2-A | 64.6% | 18.9% | 16.6% | 39.9 | 32.9 |
| Composition 2-B | 15.6% | 19.5% | 64.9% | 47.5 | 38.3 |
| Composition 2-C | 16.6% | 68.3% | 15.1% | 34.4 | 31.1 |
| Decyltrimethyl | 100.0% | 0.0% | 0.0% | 69.0 | 69.0 |
| Ammonium | | | | | |
| Chloride | | | | | |
| Dimethyloctyl | 0.0% | 0.0% | 100.0% | 62.5 | 62.2 |
| Amine Oxide | | | | | |
| Sodium Decyl | 0.0% | 100.0% | 0.0% | 62.1 | 61.1 |
| Sulfate | | | | | |
| (POLYSTEP | | | | | |
| B-25) | | | | | |

The results show that the samples containing the surfactant blend of the present technology rapidly approach a lower surface tension compared to the samples containing a single surfactant.

The present technology is now described in such full, clear and concise terms as to enable a person skilled in the art to which it pertains, to practice the same. It is to be understood that the foregoing describes preferred embodiments of the present technology and that modifications may be made therein without departing from the spirit or scope of the present technology as set forth in the appended claims. Further, the examples are provided to not be exhaustive but illustrative of several embodiments that fall within the scope of the claims.

What is claimed is:

1. A firefighting foam concentrate comprising:
(a) a surfactant blend in an amount of about 25% to about 38% by weight of the concentrate, the surfactant blend comprising:
(i) a cationic surfactant having the general formula: 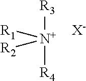
where R₁ is a straight or branched, saturated or unsaturated, alkyl or alkene chain having an average chain length of 8 to 10 carbon atoms;
R₂ is H or a straight or branched, saturated or unsaturated, alkyl or alkene chain having from 1 to 10 carbon atoms;
R₃ is H, methyl, or ethyl;
R₄ is H, methyl, or ethyl; and
X⁻ is a monovalent anionic counterion, preferably a halide, most preferably Cl⁻ or Br⁻;
(ii) an alkyl amine oxide nonionic surfactant having an alkyl moiety with an average carbon chain length of 8 to 10 carbon atoms;
(iii) an anionic surfactant having the general formula: 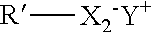
where R′ is a straight or branched, saturated or unsaturated, alkyl or alkene chain having an average chain length of 8 to 10 carbon atoms, X₂⁻ is a sulfate group, and Y⁺ is a cationic counter ion preferably selected from the group consisting of sodium, potassium, ammonium, and substituted ammonium;
wherein the cationic surfactant, the nonionic surfactant, and the anionic surfactant are present in the surfactant blend in a molar ratio of about 0.25-1.0:0.25-1.0:0.25-1.0; and
(b) water to total 100% by weight of the concentrate.

2. The firefighting foam concentrate of claim 1, wherein the cationic surfactant is selected from the group consisting of octyltrimethylammonium chloride, octyltrimethylammonium bromide, decyltrimethylammonium chloride, decyltrimethylammonium bromide, and combinations thereof.

3. The firefighting foam concentrate of claim 1, wherein the nonionic surfactant is selected from the group consisting of octyldimethylamine oxide, decyldimethylamine oxide, and combinations thereof.

4. The firefighting foam concentrate of claim 1, wherein the anionic surfactant is selected from the group consisting of octyl sulfate, decyl sulfate, and combinations thereof.

5. The firefighting foam concentrate of claim 1, wherein the firefighting foam concentrate is substantially free of or does not contain a fluorinated compound.

6. The firefighting foam concentrate of claim 1, wherein the surfactant blend is in an amount of 30% to about 35% by weight of the concentrate.

7. The firefighting foam concentrate of claim 1, wherein the molar ratio of surfactants in the surfactant blend is about 1:1:1.

8. The firefighting foam concentrate of claim 1, wherein the firefighting foam concentrate reduces the surface tension of an aqueous solution to 25.5 mN/m or less.

9. The firefighting foam concentrate of claim 1, wherein the firefighting foam concentrate or an aqueous dilution thereof can reach a meso-equilibrium surface tension in about 100 ms.

10. A firefighting foam composition comprising:
(a) about 0.5% to about 12% by weight of the composition of a surfactant blend comprising
(i) a cationic surfactant having the general formula: 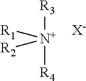
where R₁ is a straight or branched, saturated or unsaturated, alkyl or alkene chain having an average chain length of 8 to 10 carbon atoms;
R₂ is H or a straight or branched, saturated or unsaturated, alkyl or alkene chain having from 1 to 10 carbon atoms;
R₃ is H, methyl, or ethyl;
R₄ is H, methyl, or ethyl; and
X⁻ is a monovalent anionic counterion, preferably a halide, most preferably Cl⁻ or Br⁻;
(ii) an alkyl amine oxide nonionic surfactant having an alkyl moiety with an average carbon chain length of 8 to 10 carbon atoms;
(iii) an anionic surfactant having the general formula: 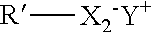
where R′ is a straight or branched, saturated or unsaturated, alkyl or alkene chain having an average chain length of 8 to 10 carbon atoms, X₂⁻ is a sulfate group, and Y⁺ is a cationic counter ion preferably selected from the group consisting of sodium, potassium, ammonium, and substituted ammonium;
wherein the cationic surfactant, the nonionic surfactant, and the anionic surfactant are present in the surfactant blend in a molar ratio of about 0.25-1.0:0.25-1.0:0.25-1.0;
(b) at least one additive selected from the group consisting of thickeners, foam stabilizers, and polymers; and
(c) water to total 100% by weight of the composition.

11. The firefighting foam composition of claim 10, wherein the cationic surfactant is selected from the group consisting of octyltrimethylammonium chloride, octyltrimethylammonium bromide, decyltrimethylammonium chloride, decyltrimethylammonium bromide, and combinations thereof.

12. The firefighting foam composition of claim 10, wherein the nonionic surfactant is selected from the group consisting of octyldimethylamine oxide, decyldimethylamine oxide, and combinations thereof.

13. The firefighting foam composition of claim 10, wherein the anionic surfactant is selected from the group consisting of octyl sulfate, decyl sulfate, and combinations thereof.

14. The firefighting foam composition of claim 10, wherein the molar ratio of surfactants in the surfactant blend is about 1:1:1.

15. A method for fighting a fire comprising:
(a) aerating a firefighting foam composition to form an aerated firefighting foam; and
(b) applying the aerated firefighting foam to a fire, or to a surface of a volatile flammable liquid, wherein the firefighting foam composition comprises water and about 0.5% to about 12% by weight of the composition of a surfactant blend comprising:
(i) a cationic surfactant having the general formula: 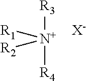
where R₁ is a straight or branched, saturated or unsaturated, alkyl or alkene chain having an average chain length of 8 to 10 carbon atoms;
R₂ is H or a straight or branched, saturated or unsaturated, alkyl or alkene chain having from 1 to 10 carbon atoms;
R₃ is H, methyl, or ethyl;
R₄ is H, methyl, or ethyl; and
X⁻ is a monovalent anionic counterion, preferably a halide, most preferably Cl⁻ or Br⁻;
(ii) an alkyl amine oxide nonionic surfactant having an alkyl moiety with an average carbon chain length of 8 to 10 carbon atoms; and
(iii) an anionic surfactant having the general formula: 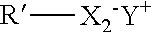
where R′ is a straight or branched, saturated or unsaturated, alkyl or alkene chain having an average chain length of 8 to 10 carbon atoms, X₂⁻ is a sulfate group, and Y⁺ is a cationic counter ion preferably selected from the group consisting of sodium, potassium, ammonium, and substituted ammonium;
wherein the cationic surfactant, the nonionic surfactant, and the anionic surfactant are present in the surfactant blend in a molar ratio of about 0.25-1.0:0.25-1.0:0.25-1.0.

16. The method of claim 15, further comprising prior to aerating, mixing the firefighting foam composition with a diluent to dilute the firefighting foam composition.

17. The method of claim 16, wherein the diluent comprises municipal water, brine, salt water, or a mixture thereof.

18. The method of claim 15, wherein the cationic surfactant is selected from the group consisting of octyltrimethylammonium chloride, octyltrimethylammonium bromide, decyltrimethylammonium chloride, decyltrimethylammonium bromide, and combinations thereof.

19. The method of claim 15, wherein the nonionic surfactant is selected from the group consisting of octyldimethylamine oxide, decyldimethylamine oxide, and combinations thereof.

20. The method of claim 15, wherein the anionic surfactant is selected from the group consisting of octyl sulfate, decyl sulfate, and combinations thereof.
